(19) United States
(12) Patent Application Publication
(10) Pub. No.: US 2016/0336132 A1
(43) Pub. Date: Nov. 17, 2016

(54) METHOD FOR CONTROLLING A CHANGE OF OPERATING STATE OF AN ELECTROMECHANICAL COMPONENT, FOR EXAMPLE A RELAY, AND CORRESPONDING DEVICE

(71) Applicant: STMICROELECTRONICS (ROUSSET) SAS, Rousset (FR)

(72) Inventor: Patrick FULCHERI, Biot (FR)

(21) Appl. No.: 14/960,546

(22) Filed: Dec. 7, 2015

(30) Foreign Application Priority Data
May 13, 2015 (FR) 1554326

(51) Int. Cl. H01H 47/32

(52) U.S. Cl. CPC H01H 47/32

(57) ABSTRACT

A method is for controlling a change of an electromechanical component between a first operating state and a second operating state. The method may include changing from the first operating state to the second operating state by generating a first current flowing through the electromechanical component, prior to the generation of the first current, charging a capacitor, and simultaneously with the generation of the first current, partial discharging the capacitor through the electromechanical component to cause an additional current to flow in the electromechanical component, the additional current being added to the first current. The method may include changing from the second operating state to the first operating state by generating a second current flowing in a direction opposite to the first current in the electromechanical component, and prior to the flowing of the second current, discharging the capacitor.

### RELATED APPLICATION

This application is based upon prior filed copending French Application No. 1554326 filed May 13, 2015, the entire subject matter of which is incorporated herein by reference in its entirety.

### TECHNICAL FIELD

The present application relates to control of an electromechanical component, and more particularly, to control of a change of the component from a first operating state to a second operating state.

### BACKGROUND

Typically, an electromechanical component comprises an inductive element, such as a coil, coupled between two transistor half-bridges powered by a direct current (DC) power supply source, making it possible to cause a current to flow in the coil in one direction or the other depending on whether it is desired to make the component change from its first operating state to its second operating state or vice-versa, for example, depending on whether it is desired to activate the relay or to deactivate it. In general, one of the currents, for example, the activation current, generated by the power supply source is higher than the other, for example, the deactivation current.

The control of an electromechanical component comprising a coil across two transistor half-bridges generally necessitates a relatively high power, for example, of the order of 220 mW for a small sized bistable relay. Moreover, when a low voltage power supply source is used, it is necessary to have a power supply source, for example, a battery, having a low internal resistance as well as transistors having a low internal resistance in the conducting state (i.e. the “ON” state). Moreover, as the battery becomes smaller, its internal resistance may become increasingly significant.

### SUMMARY

Generally speaking, a method is for controlling a change of an electromechanical component between a first operating state and a second operating state. The method may include changing from the first operating state to the second operating state by at least generating a first current flowing through the electromechanical component, the first current being generated by a DC power supply and being greater than a second current, prior to the generation of the first current, charging a capacitor, and simultaneously with the generation of the first current, at least partial discharging the capacitor through the electromechanical component to cause an additional current to flow in the electromechanical component, the additional current being added to the first current. The method may include changing from the second operating state to the first operating state by at least generating the second current with the DC power supply and flowing in a direction opposite to the first current in the electromechanical component, and prior to the flowing of the second current, discharging the capacitor.

### BRIEF DESCRIPTION OF THE DRAWINGS

FIG. 1 is a schematic circuit diagram of an electronic device, according to the preset disclosure.

FIG. 2 is a schematic circuit diagram of the electronic device of FIG. 1 in an initial first configuration.

FIG. 3 is a schematic circuit diagram of the electronic device of FIG. 1 in a first configuration.

FIG. 4 is a schematic circuit diagram of the electronic device of FIG. 1 in an activation cycle.

FIG. 5 is a schematic circuit diagram of the electronic device of FIG. 1 in an initial second configuration.

FIG. 6 is a schematic circuit diagram of the electronic device of FIG. 1 in a second configuration.

FIG. 7 is a schematic circuit diagram of the electronic device of FIG. 1 in a final configuration.

### DETAILED DESCRIPTION

At present for low consumption applications using low voltage power supply sources, one approach may comprise permanently coupling onto the battery a capacitor forming an energy store. However, such capacitors, generally of low cost and having a value of several hundred microfarads, may exhibit significant leakages resulting in permanent current losses. Another approach may include using batteries having a low internal resistance. However, such batteries may be expensive or are larger. Another approach may include using more costly half-bridges in order to lower their internal resistance in the ON state.

The present disclosure may provide efficient control of the change of an electromechanical component from one operating state to another, even using small-sized DC power supply sources having significant internal resistances and/or transistor half-bridges also having significant internal resistances in the ON state. According to an embodiment, a method includes coupling a capacitor on the side of the half-bridge carrying the highest current in order to cause the electromechanical component to change from one of these operating states to the other, for example, during the activation of a relay, and charging this capacitor before causing the current to flow in the coil of the relay and then to discharge this capacitor through the coil in such a way as to generate an additional current which will be added to the current generated by the dc power supply source.

Thus, a method is for controlling the change of an electromechanical component from a first operating state to a second operating state and vice-versa. The change of the component from its first operating state to its second operating state, for example, the activation of a relay, comprises the flowing in an inductive element of the component of a first current generated by a dc power supply and higher than a second current generated by the dc power supply and flowing in the opposite direction in the inductive element during the change from the second operating state to the first operating state, for example, during the deactivation of the relay. The change from the first operating state to the second operating state comprises, prior to the flowing of the first current, a charging of a capacitor and then, simultaneously with the generation of the first current, a discharging of the capacitor through the inductive element in such a way as to cause to flow in the inductive element an additional current which is added to the first current.

Moreover, the change from the second operating state to the first operating state comprises, prior to the flowing of the second current, a discharging of the capacitor. Thus, the presence of this capacitor, which makes it possible, at least at the start of the activation of the electromechanical component, to cause an additional current to flow in the coil of the electromechanical component, allows the use of small sized and inexpensive batteries. Moreover, because of the presence of this additional current generated by the capacitor, the side of the half-bridge carrying the highest current can be “weak”, that is to say it can have a significant resistance in the ON state, which allows the use of low cost components or even fewer components since it is even possible to use the output port of a conventional microcontroller in certain cases.

According to one embodiment, the method can comprise an additional phase of discharging the capacitor after each change of the electromechanical component from one of its two states to its other state. Such a phase thus allows a time saving when changing from the second state to the first operating state (typically during the deactivation of the relay). Moreover, the fact of providing this additional phase during the change from the first operating state (typically during the activation of the relay) makes it possible to have symmetrical behavior from one cycle to the other, i.e. during the activation and during the deactivation.

According to another aspect, an electronic device may include a DC power supply source capable of generating a first current and a second current lower than the first current, and an electromechanical component comprising an inductive element and having a first operating state and a second operating state. The electronic device may include a control module powered by the power supply source and having a first control terminal and a second control terminal respectively coupled to the two terminals of the inductive element and capable of adopting a first configuration allowing a flow of the first current from the first control terminal to the second control terminal in order to cause the component to change from its first operating state to its second operating state and a second configuration allowing a flow of the second current from the second control terminal to the first control terminal in order to cause the component to change from its second operating state to its first operating state. The control module may also comprise a capacitor.

The control module is furthermore capable of adopting, prior to the first configuration, an initial first configuration allowing a charging of the capacitor and then allowing, during its first configuration a discharge, at least partial, of the capacitor through the inductive element in order to cause an additional current to flow in it which is added to the first current. Also, the control module is furthermore capable of adopting, prior to the second configuration, an initial second configuration allowing a discharging of the capacitor.

Additionally, the DC power supply source comprises a positive terminal and a negative terminal, the capacitor is coupled between the first control terminal and the negative terminal. The control module may include a first switch and a second switch coupled in series between the positive terminal and the negative terminal of the voltage source and having a first common node forming the first control terminal, a third switch and a fourth switch coupled in series between the positive terminal and the negative terminal of the voltage source and having a second common node forming the second control terminal, and control means or a controller. The controller may be configured to close the first switch and open the other switches in order to place the control module in its initial first position and then to close the first and fourth switches and open the other switches in order to place the control module in its first configuration, and close the second switch and open the other switches in order to place the control module in its initial second configuration and then to close the second and third switches and open the other switches in order to place the control module in its second configuration.

The control module is furthermore capable of adopting a final configuration, after the first configuration and the second configuration, allowing a discharging of the capacitor. Thus, the controller is, for example, configured to close the second switch and open the other switches in order to place the control module in its final configuration.

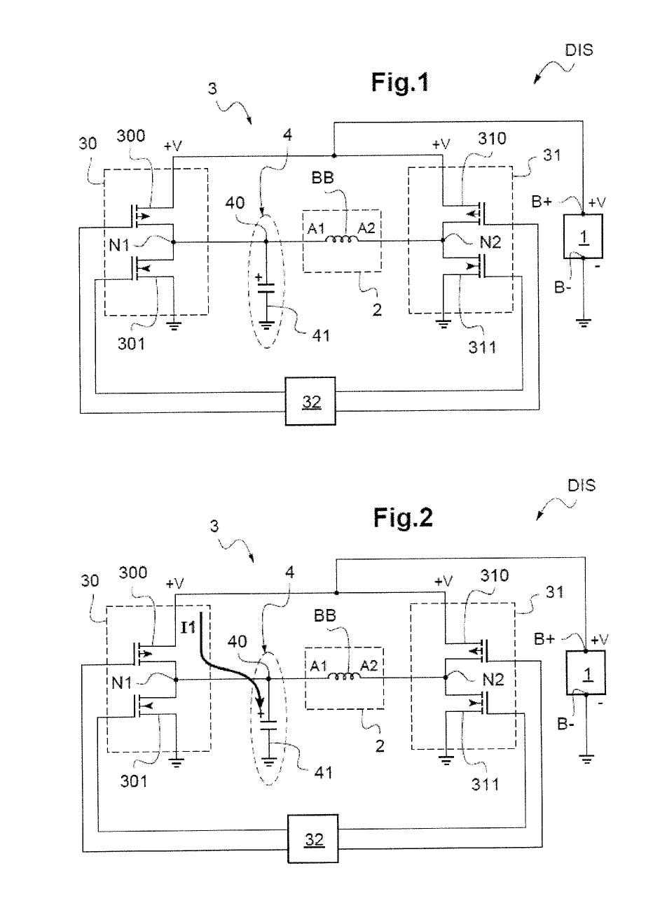

In FIG. 1, the reference DIS denotes an electronic device comprising a DC power supply source 1, for example, a battery or cells, rechargeable or not, delivering an off-load voltage +V. The reference numeral 2 denotes an electromechanical component, for example, a relay, comprising an inductive element BB such as a coil, having two terminals A1 and A2.

The device DIS comprises a control module 3 powered by the power supply source 1 and having a first control terminal N1 and a second control terminal N2 respectively coupled to the two terminals A1 and A2 of the inductive element BB. In this example of embodiment, the control module 3 comprises a first transistor half-bridge 30 comprising a first switch 300, in this case a PMOS transistor, and a second switch 301, in this case an NMOS transistor, coupled in series between the positive terminal B+ and the negative terminal B− (the ground) of the voltage source 1. The first control terminal N1 is formed by the two coupled drains of the two transistors 300 and 301.

The control module 3 comprises a second transistor half-bridge 31 in this case comprising a third switch 310, for example, a PMOS transistor, and a fourth switch 311, for example, an NMOS transistor, coupled in series between the positive terminal B+ and the negative terminal B− of the DC power supply source 1. The second control terminal N2 is formed by the two coupled drains of the transistors 310 and 311.

The four transistors 300, 301, 310 and 311 are controlled on their respective gates by control signals delivered by controller 32, which can, for example, be embodied in a software manner within a microcontroller. In addition to the components that have just been described, the device DIS also comprises a capacitor 4 having a first terminal 40 coupled to the first control terminal N1 as well as to the first terminal A1 of the coil BB and a second terminal 41 coupled to the negative terminal B− of the power supply source.

As will be seen in more detail below, the control module 3 and the capacitor 4 are intended to control the change of the electromechanical component 2 from a first operating state to a second operating state. When this electromechanical component is, for example, a relay, the first operating state is, for example, a deactivated state and the second operating state is then an activated state.

The change from the first operating state to the second operating state consequently corresponds to the activation of the relay while the change from the second operating state to the first operating state corresponds to the deactivation of the relay. The change of the electromechanical component 2 from one operating state to another comprises the flowing of a current in the inductive element BB. Moreover, one of the currents is generally higher than the other.

This is notably the case when the electromechanical component is a bistable relay. In fact, the current necessary for the activation of the relay is generally higher than that necessary for its deactivation since, during the activation, the magnetic gap is greater, and the permanent magnetic flux is weak whereas, during the deactivation, the magnetic gap is zero because the relay is engaged and it is only necessary to cancel the permanent magnetic flux in order to disengage the relay, i.e. to deactivate it.

In the example described here, the activation of the relay will result in a current flowing in the coil BB from the terminal A1 to the terminal A2 while the deactivation will result in a current flowing in the coil from the terminal A2 to the terminal A1. Also, since the activation current is higher than the deactivation current, the capacitor 4 is coupled at the level of the first control terminal N1 that is to say on the side of the half-bridge 30 intended to carry the highest current.

Reference will now more particularly be made to FIGS. 2 to 7 in order to illustrate an example of operation of the device DIS shown in FIG. 1. FIGS. 2 to 4 relate to the activation of the electromechanical relay 2, i.e. to the change of the relay from its first operating state (deactivated state) to its second operating state (activated state).

Referring more particularly now to FIG. 2, it can be seen that the control module 3 adopts an initial first configuration in which the first switch 300 is closed (transistor ON) while the other switches 301, 310 and 311 are open (transistors OFF). This initial first configuration allows a charging of the capacitor 4 by a current I1 delivered by the DC power supply source 1.

Those skilled in the art will know how to adjust the time necessary for placing the control module in this initial first configuration in order to charge the capacitor. This of course depends on the size of the capacitor. Thus, for a capacitor having a capacitive value of between about ten microfarads and a few hundred microfarads, the charging time can be of the order of a few milliseconds to several tens of milliseconds.

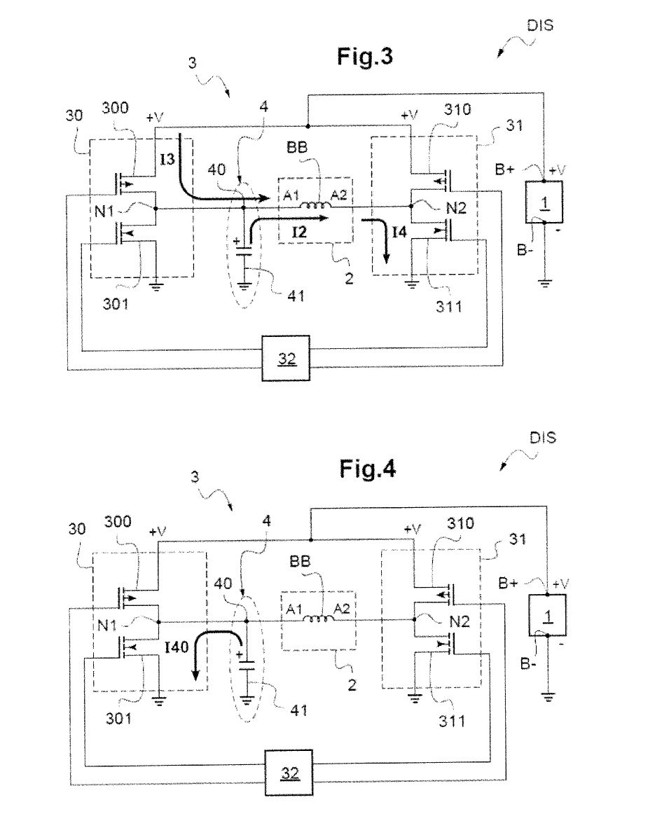

Then, as shown in FIG. 3, the control module adopts a first configuration in which the first switch 300 and the fourth switch 311 are closed and the other switches 301 and 310 are open. In this first configuration, the battery 1 forms, with its internal resistance and the internal resistance of the transistor 300 in the ON state, a first current source, and the capacitor 4 which has been charged with the off-load voltage +V of the battery, forms, with its low internal resistance, a second current source. These two current sources are in parallel.

Moreover, at the start, the current source formed by the capacitor 4 and its low impedance is preponderant in comparison with the current source formed by the battery, its internal resistance and the internal resistance of the transistor 300. Because of this, the capacitor 4 can discharge through the coil BB in order to supply an additional current I2 which will be added to the current I3 delivered by the battery 1. The resultant current I4 having passed through the coil BB then discharges to ground via the transistor 311.

The capacitor 4 discharges to the point of equilibrium of the voltages and only at that time does the current I3 delivered by the battery flow in the coil BB. Thus, the capacitor 4 has allowed, during the activation of the relay, the supply of an additional current at the start, which makes it possible to overcome the possible negative effects due to a high internal resistance of the battery and/or the transistor 300.

Referring now to FIG. 4, it can be seen that the activation cycle preferably ends with a discharging of the capacitor 4 to ground (discharge current I40). For this purpose, the control module 3 adopts a final configuration allowing the discharge of the capacitor 4. In this final configuration, the controller 32 closes the second switch 301 and open the other switches 300, 310 and 311.

Here again, the switch 301 is left closed for enough time to allow an effective discharge of the capacitor 4. By way of indication, a few milliseconds may be necessary. Then, the controller 32 places the control module in a state of rest in which all of the switches 300, 301, 310 and 311 are open (transistors OFF).

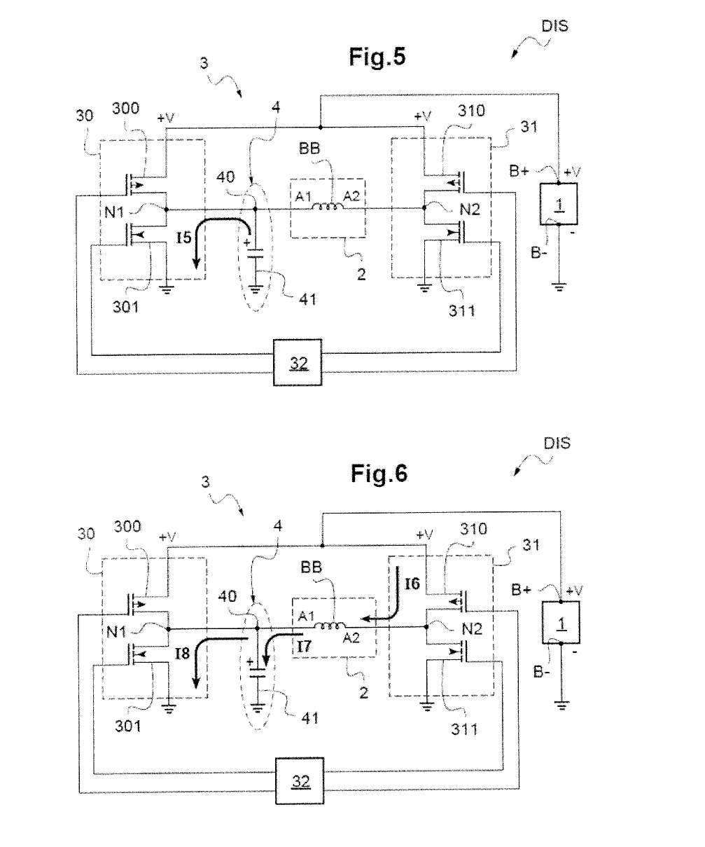

Reference is now made to FIGS. 5 to 7 in order to illustrate an example of operation of the device DIS during the deactivation of the relay. For this deactivation, the controller 32 places the control module in an initial second configuration illustrated in FIG. 5, in which it controls the second switch 301 in such a way as to make it conductive in order to allow a discharge of the capacitor 4 (discharge current I5). In fact, this makes it possible to ensure that the capacitor 4 is empty before proceeding with the actual deactivation of the relay.

Then, as shown in FIG. 6, the controller 32 places the control module in a second configuration in which the third switch 310 and the second switch 301 are closed while the other switches 300 and 311 are open. Because of this, a current I6 delivered by the power supply source 1 flows in the coil BB from the terminal A2 to the terminal A1 and this current I6 then subdivides at the beginning of the deactivation phase into a current I7 charging the capacitor 4 and a current I8 discharging to ground.

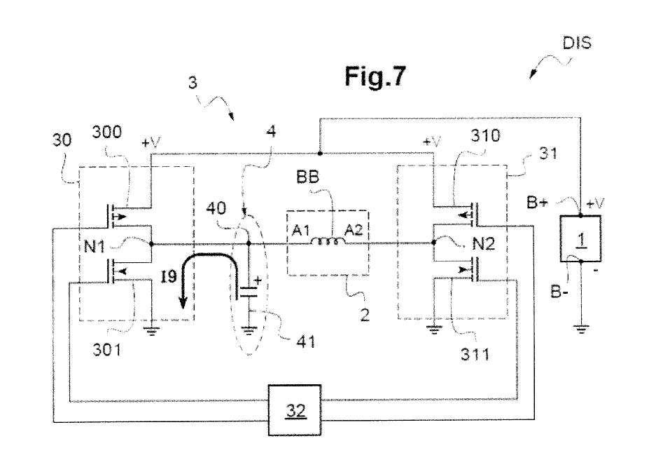

The capacitor 4 will be charged up to the point of equilibrium of voltages and at that moment the current I7 is cancelled out and only the current I8 remains. Then, as shown in FIG. 7, the controller 32 again places the control module 3 in its final configuration in which the transistor 301 is ON, in order to discharge the capacitor 4 via the discharge current I9. Then, the controller again places the control module in its state of rest in which all of the switches are open.

The size of the capacitor 4 depends on the characteristics of the electromechanical component. This being so, a capacitor having the capacitive value mentioned above (i.e. a few tens of microfarads to a few hundred microfarads) makes it possible to activate or to deactivate a bistable relay having a power rating of a few tens of milliwatts.

It will be noted here that the capacitor 4 does not consume power outside of the active phases of activation and of deactivation. In fact, outside of these phases, when the control module is in the state of rest, the capacitor 4 is electrically isolated from the battery 1. Consequently, the possible leakages of the capacitor have no importance, which makes it possible to use a low-cost capacitor.

Moreover, since the capacitor 4 makes it possible to have a half-bridge 30 having a reduced internal resistance in the ON state, it would be entirely possible to use the transistors integrated in the output port of a microcontroller for the transistors 300 and 301. However, in the case where high power is necessary for the activation and deactivation of the relay, it would of course still be necessary to provide transistors 300 and 301 of appropriate size and which would then be outside of the microcontroller 32.

1-6. (canceled)

7. A method for controlling a change of an electromechanical component from a first operating state to a second operating state, the change of the electromechanical component from the first operating state to the second operating state comprising generating a first current flowing through an inductive element of the electromechanical component, the first current being generated by a direct current (DC) power supply and being greater than a second current, the second current being generated by the DC power supply and flowing in a direction opposite to the first current in the inductive element during the change from the second operating state to the first operating state, the method comprising:
changing from the first operating state to the second operating state by at least
prior to the generating of the first current, charging a capacitor, and
simultaneously with the generating of the first current, at least partial discharging the capacitor through the inductive element to cause an additional current to flow in the inductive element, the additional current being added to the first current, and
changing from the second operating state to the first operating state by at least
prior to the flowing of the second current, discharging the capacitor.

8. The method according to claim 7 further comprising an additional discharging of the capacitor after each change of the electromechanical component between the first and second operating states.

9. A method for controlling a change of an electromechanical component between a first operating state and a second operating state, the method comprising:
changing from the first operating state to the second operating state by at least
generating a first current flowing through the electromechanical component, the first current being generated by a direct current (DC) power supply and being greater than a second current,
prior to the generating of the first current, charging a capacitor, and
simultaneously with the generating of the first current, at least partial discharging the capacitor through the electromechanical component to cause an additional current to flow in the electromechanical component, the additional current being added to the first current; and
changing from the second operating state to the first operating state by at least
generating the second current with the DC power supply and flowing in a direction opposite to the first current in the electromechanical component, and
prior to the flowing of the second current, discharging the capacitor.

10. The method according to claim 9 wherein the DC power supply comprises a positive terminal and a negative terminal, the capacitor being coupled between the first control terminal and the negative terminal.

11. The method according to claim 10 wherein a first switch and a second switch are coupled in series between the positive terminal and the negative terminal of the DC power supply.

12. The method according to claim 11 a third switch and a fourth switch are coupled in series between the positive terminal and the negative terminal of the DC power supply.

13. The method according to claim 12 further comprising:
closing the first switch and opening the second, third, and fourth switches to place a control module in an initial first configuration;
closing the first and fourth switches and opening the second and third switches to place the control module in a first configuration;
closing the second switch and opening the first, third, and fourth switches to place the control module in the initial second configuration; and
closing the second and third switches and opening the first and fourth switches to place the control module in a second configuration.

14. The method according to claim 13 further comprising operating in a final configuration, after the first configuration and the second configuration, for allowing a discharge of the capacitor.

15. The method according to claim 14 further comprising closing the second switch and opening the first, third, and fourth switches to place the control module in the final configuration.

16. The method according to claim 9 wherein the electromechanical component comprises an inductive element.

17. An electronic device comprising:
a direct current (DC) power supply configured to generate a first current and a second current less than the first current;
an electromechanical component configured to have a first operating state and a second operating state;
a control module comprising a first control terminal and a second control terminal respectively coupled to first and second terminals of the electromechanical component, said control module configured to
be powered by said DC power supply,
operate in a first configuration for causing the first current to flow from the first control terminal to the second control terminal to cause the electromechanical component to change from the first operating state to the second operating state, and
operate in a second configuration for causing the second current to flow from the second control terminal to the first control terminal to cause the electromechanical component to change from the second operating state to the first operating state,
said control module comprising a capacitor and configured to
prior to the first configuration, operate in an initial first configuration for charging said capacitor,
during the first configuration, at least partially discharge the capacitor through said electromechanical component to cause an additional current to flow, the additional current being added to the first current, and
prior to the second configuration, operate in an initial second configuration for discharging said capacitor.

18. The electronic device according to claim 17 wherein said DC power supply comprises a positive terminal and a negative terminal, said capacitor being coupled between the first control terminal and the negative terminal.

19. The electronic device according to claim 18 wherein said control module comprises a first switch and a second switch coupled in series between the positive terminal and the negative terminal of said DC power supply; and wherein said first and second switches have a first common node defining the first control terminal.

20. The electronic device according to claim 19 wherein said control module comprises a third switch and a fourth switch coupled in series between the positive terminal and the negative terminal of said DC power supply; and wherein said third and fourth switches have a second common node defining the second control terminal.

21. The electronic device according to claim 20 wherein said control module comprises a controller configured to:
close the first switch and open the second, third, and fourth switches to place said control module in the initial first configuration;
close the first and fourth switches and open the second and third switches to place the control module in the first configuration;
close the second switch and open the first, third, and fourth switches to place said control module in the initial second configuration; and
close the second and third switches and open the first and fourth switches to place said control module in the second configuration.

22. The electronic device according to claim 21 wherein said control module is configured to operate in a final configuration, after the first configuration and the second configuration, for allowing a discharge of said capacitor.

23. The electronic device according to claim 22 wherein said controller is configured to close the second switch and open the first, third, and fourth switches to place said control module in the final configuration.

24. The electronic device according to claim 17 wherein said electromechanical component comprises an inductive element.

25. An electronic device comprising:
an electromechanical component having first and second terminals, and configured to have a first operating state and a second operating state;
a control module comprising
first and second control terminals respectively coupled to said first and second terminals of the electromechanical component, and
a capacitor coupled to said first control terminal;
said control module configured to
operate in a first configuration for causing a first current to flow from the first control terminal to the second control terminal to cause the electromechanical component to change from the first operating state to the second operating state,
operate in a second configuration for causing a second current to flow from the second control terminal to the first control terminal to cause the electromechanical component to change from the second operating state to the first operating state,
prior to the first configuration, operate in an initial first configuration for charging said capacitor,
during the first configuration, at least partially discharge the capacitor through said electromechanical component to cause an additional current to flow, the additional current being added to the first current, and
prior to the second configuration, operate in an initial second configuration for discharging said capacitor.

26. The electronic device according to claim 25 wherein said control module comprises a first switch and a second switch coupled in series; and wherein said first and second switches have a first common node defining the first control terminal.

27. The electronic device according to claim 26 wherein said control module comprises a third switch and a fourth switch coupled in series; and wherein said third and fourth switches have a second common node defining the second control terminal.

28. The electronic device according to claim 27 wherein said control module comprises a controller configured to:
close the first switch and open the second, third, and fourth switches to place said control module in the initial first configuration;
close the first and fourth switches and open the second and third switches to place the control module in the first configuration;
close the second switch and open the first, third, and fourth switches to place said control module in the initial second configuration; and
close the second and third switches and open the first and fourth switches to place said control module in the second configuration.

29. The electronic device according to claim 28 wherein said control module is configured to operate in a final configuration, after the first configuration and the second configuration, for allowing a discharge of said capacitor.

30. The electronic device according to claim 29 wherein said controller is configured to close the second switch and open the first, third, and fourth switches to place said control module in the final configuration.

31. The electronic device according to claim 25 wherein said electromechanical component comprises an inductive element.
